(19) United States
(12) Patent Application Publication
(10) Pub. No.: US 2009/0032739 A1
(43) Pub. Date: Feb. 5, 2009

(54) Method and System for Charged-Particle Beam Lithography

(75) Inventor: Yuichi Kawase, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: JEOL LTD., Tokyo (JP)

(21) Appl. No.: 12/182,471

(22) Filed: Jul. 30, 2008

(30) Foreign Application Priority Data
Jul. 30, 2007 (JP) 2007-197399

(51) Int. Cl. G21K 5/10

(52) U.S. Cl. 250/492.23

(57) ABSTRACT

Charged-particle beam lithography method and system. The lithography system has a map creation unit and a lithographic data creation unit. The map creation unit creates a proximity effect correction amount map from pattern data supplied from a pattern data file, pattern layout information, a foggy error correction amount map, loading effect correction amount maps, a process error correction amount map, a transfer error correction amount map, proximity effect correction parameters, and a proximity effect correction map. The lithographic data creation unit creates lithographic data based on the pattern data from the pattern data file, creates shot time data based on the proximity effect correction amount map from the map creation unit, and attaches the created shot time data to the lithographic data.

### BACKGROUND OF THE INVENTION

1. Field of the Invention

The present invention relates to a method and system for charged-particle beam lithography. It relates to finding an optimum lithography dose by performing correction computations taking account of mutual effects of proximity effect correction, foggy error correction, and process error correction and calculating the optimum dose based on the results of the computations.

2. Description of Related Art

A method of charged-particle beam lithography is a method for writing a desired pattern at a desired position on a material by applying a resist on a substrate to prepare the material and shooting a charged-particle beam at the desired position. It is thus possible to fabricate semiconductor devices of quite high density.

In this method of charged-particle beam lithography, the dose is corrected for each shot in order to correct various effects including proximity effects, foggy errors, process errors, and transfer errors.

Systems of this kind are described, for example, in JP2003-151885 and U.S. Pat. No. 6,845,497. In particular, an exposure pattern is divided into plural regions established taking account of ranges of effects of backscattering, Coulomb effect, and process-induced dimensional errors. The pattern area occupancy ratio in each cell, i.e., pattern area density, is stored. Exposure is performed using a pattern in which amounts of deformation of the pattern have been found as a function of the pattern area densities.

A system utilizing a correction technique for modulating the lithography dose by the area rate when dimensional errors of a transfer pattern due to variations in density of the source pattern are corrected is known, as described in JP2003-133209. The system carries out a process consisting of the steps of: defining a first area rate α1 of the source pattern for a narrow area of a mask region and a second area rate α2 of the source pattern for a wider area, setting the first and second area rates for each correction cell, setting one modulation parameter for each of the combinations of the first and second area rates in accordance with a given relationship, finding a corrected exposure value (reference exposure×modulation parameter), and using the found corrected exposure value as a lithographic exposure value.

With respect to dose correction for correcting the effects of the aforementioned proximity effects, foggy errors, process errors, and transfer errors, each individual effect is estimated without taking account of mutual effects in order to simplify the computational processing and concept. The found correction doses are simply added up. This sequence of operations is performed for each shot.

However, the magnitudes of the proximity effects and foggy errors are varied by shot-to-shot dose variations. Therefore, if correction doses obtained by estimating each individual effect alone are used, the correction dose results in overdose or underdose.

In many cases, it cannot be said that sufficiently accurate dose correction is made because these overdose and underdose shots are adjusted using empirically obtained parameters during observation of the results of the lithography.

### SUMMARY OF THE INVENTION

It is an object of the present invention to provide a method and system for charged-particle beam lithography for making dose corrections that produce sufficient accuracy with simple processing.

A method of charged-particle beam lithography, according to the present invention, is used to delineate a pattern at a desired position on a material having a resist applied thereon. A charged-particle beam is shot at the desired position on the material. This method is characterized in that the dose of the charged-particle beam on the resist is corrected in such a way that an appropriate energy level relative to the incident energy of the charged-particle beam (level appropriate for the incidence) is coincident with an energy level (process level) necessary for process steps, such as development and etching of the resist applied on the material.

A charged-particle beam lithography system, according to the present invention, is used to delineate a pattern at a desired position on a material on which a resist is applied by shooting a beam of charged particles at the desired position on the material based on lithographic data. The system has a map creation unit and a data creation unit. The map creation unit creates proximity effect correction amount maps from pattern data, pattern layout information, foggy error correction amount maps, loading effect correction amount maps, process error correction amount maps, transfer error correction amount maps, proximity effect correction parameters, and proximity effect correction maps. The data creation unit creates lithographic data based on the pattern data, creates shot time data based on the proximity effect correction amount maps from the map creation unit, and attaches the created shot time data to the lithographic data.

According to the present invention, a method and system for charged-particle beam lithography are obtained which make dose corrections providing sufficient accuracy by simple processing.

These and other objects and advantages of the present invention will become more apparent as the following description proceeds.

### BRIEF DESCRIPTION OF THE DRAWINGS

FIG. 1 is a block diagram of a system according to one embodiment of the present invention;

FIG. 2 is a graph showing charged-particle energy intensities;

FIG. 3 is a graph showing variations in electron energy intensity;

FIG. 4 is a graph showing variations in electron energy intensity;

FIG. 5 is a graph showing variations in electron energy intensity;

FIG. 6 is a graph showing variations in electron energy intensity;

FIG. 7 is a graph showing variations in electron energy intensity;

FIGS. 8A and 8B show maps of the proportions of electron energies incident on individual cells (n, m) when one arbitrary geometric figure k is drawn;

FIGS. 9A and 9B show a foggy effect degree reference graph and a foggy effect degree reference map for each cell;

FIG. 10 is a graph illustrating corrections made to cope with variations in process levels; and

FIG. 11 is a graph illustrating corrections made to cope with variations in process levels.

### DESCRIPTION OF THE PREFERRED EMBODIMENTS

Embodiments of the present invention are hereinafter described in detail with reference to the drawings.

In the present invention, in order to form a pattern having desired dimensions on a material, the dose of a charged-particle beam on a resist applied on the surface of the material is varied. According to the present invention, dimensions can be controlled more accurately than the method of varying a design pattern itself. Various kinds of errors that are corrected by the present invention are first described.

(1) Proximity Effect Correction

In a method of charged-particle beam lithography, a charged-particle beam is scattered within a layer of resist (forward scattering) or transmitted through the layer of resist, enters the substrate, and is rescattered into the layer of resist from the substrate (backward scattering). Consequently, energy is stored in the unirradiated portions close to the irradiated portion. Therefore, if development is done, undeveloped portions may be produced in the desired region or the portions close to the desired portion become exposed.

These phenomena are known as proximity effects. Proximity effect correction has been made to reduce such proximity effects by correcting the dose.

(2) Foggy Error Correction

The beam of charged particles is reflected at the resist surface, hits an optical element (such as a lens or the electron optical column of the charged-particle optical system) mounted over the material, is rereflected into unirradiated portions, and enters the layer of resist where the energy is accumulated. As a result, the linewidth of the pattern to be delineated becomes different from a desired value.

This phenomenon is known as foggy error. To reduce the effects of such foggy error, the dose is corrected. This countermeasure is herein referred to as foggy error correction.

With respect to both proximity effects and foggy error, their effects are affected by the dose. Therefore, in order to correct both kinds of phenomena by means of dosing, the individual effects should not be corrected separately but both phenomena must be corrected comprehensively. Furthermore, the effects are also affected by variations in surrounding doses and, therefore, the correction dose is recalculated using the correction dose once computed.

(3) Process Error Correction and Loading Effect Correction

When a material on which a pattern has been delineated by a charged-particle beam is developed or etched, the dimensions of the delineated pattern become nonuniform due to process errors on the material surface or due to a nonuniform etch rate (loading effects) based on the etched area in the surroundings.

To reduce the effects of such process errors and loading effects, the dose has been corrected. These techniques are referred to as process error correction and loading effect correction.

(4) Transfer Error Correction

A reticle or a mask on which a pattern has been delineated by a charged-particle beam is set on a stepper, and then the pattern is transferred onto a wafer by an optical system. At this time, distortion in the optical system of the stepper produces variations in the dimensions of patterns transferred onto the wafer according to the positions of the patterns on the reticle or mask. To reduce the variations, the dose has been corrected. This countermeasure is referred to as transfer error correction.

Where the above-described countermeasures are taken, the dose of the charged-particle beam is corrected by finding a correction value of the shot time of the beam for each subregion on a blank material, such as a mask or wafer, such that a pattern having desired dimensions is formed and then adjusting the shot time of the beam, based on the correction value, such that each subregion is irradiated with the beam. Computation of the amount of correction to the dose is performed simultaneously with delineation of the pattern on the material using the beam to prevent deterioration of the lithography throughput.

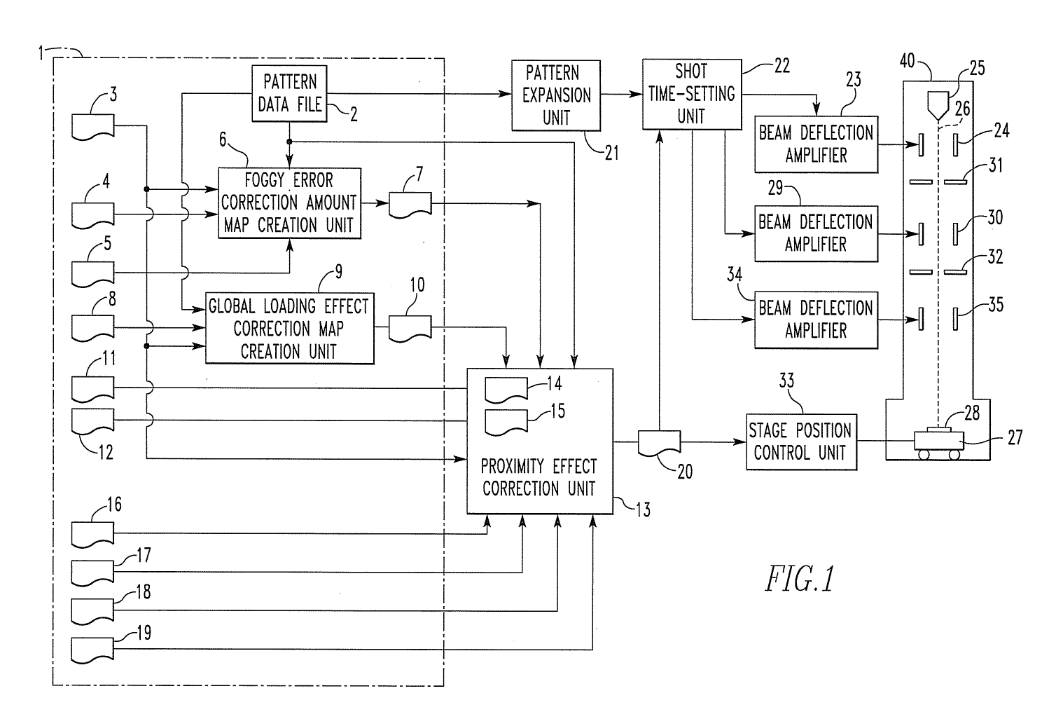

FIG. 1 is a block diagram showing an example of configuration of a system, according to the present invention. A controller 1 controls the system. An electron beam lithography system 40 delineates desired patterns on a material based on various amounts of correction found by the controller 1.

The controller 1 holds pattern layout information 3, foggy error correction parameters 4, foggy error correction maps 5, global loading effect correction parameters 8, middle range loading effect correction parameters 11, micro-loading effect correction parameters 12, process error correction amount maps 16, transfer error correction amount maps 17, proximity effect correction parameters 18, and proximity effect correction maps 19.

A pattern data file 2 stores the pattern data. A foggy error correction amount map creation unit 6 receives the pattern data from the pattern data file, the pattern layout information 3, the foggy error correction parameters 4, and the foggy error correction maps 5, performs calculations for correction of the foggy errors in accordance with a foggy error correction program, and outputs a foggy error correction amount map 7.

A global loading effect correction map creation unit 9 receives the pattern data from the pattern data file 2, the global loading effect correction parameters 8, and the pattern layout information 3, performs calculations for correction of the global loading effects in accordance with a global loading effect correction program, and outputs a global loading effect correction amount map 10.

A pattern expansion unit 21 receives the output of the pattern data file 2 and expands the pattern.

A proximity effect correction unit 13 receives the output of the pattern data file 2, the foggy error correction amount map 7, global loading effect correction amount map 10, middle range loading effect correction parameters 11, the pattern layout information 3, micro-loading effect correction parameters 12, process error correction amount maps 16, transfer error correction amount maps 17, proximity effect correction parameters 18, and proximity effect correction maps 19, performs calculations for correcting the proximity effects, and outputs a proximity effect correction amount map 20. In the correction unit 13, the middle range loading effect correction parameters 11 are converted into a middle range loading effect correction amount map 14, and the micro-loading effect correction parameters 12 are converted into a micro-loading effect correction amount map 15.

A shot time-setting unit 22 receives the output from the pattern expansion unit 21 and the proximity effect correction amount map 20 and determines a shot time.

A beam deflection amplifier 23 for controlling the shot time receives the output from the shot time-setting unit 22. A beam deflection amplifier 29 for controlling the shot size also receives the output from the shot time-setting unit 22. A beam deflection amplifier 34 for controlling the shot position also receives the output from the shot time-setting unit 22.

A stage position control unit 33 receives the proximity effect correction amount map 20 and controls the stage position.

The electron beam lithography system 40 includes an electron beam source 25 emitting an electron beam 26, blanking beam deflection electrodes 24 for deflecting the beam 26, a first beam-shaping slit 31, beam deflection electrodes 30 for shaping, a second beam-shaping slit 32, positioning beam deflection electrodes 35, a material 28 on which a pattern is to be written, and a stage 27 for placing the material 28.

The output from the beam deflection amplifier 23 for controlling the shot time is fed to the beam deflection electrodes 24 for blanking. The output from the beam deflection amplifier 29 for controlling the shot size is fed to the beam deflection electrodes 30 for shaping. The output from the beam deflection amplifier 34 for controlling the shot position is fed to the beam deflection electrodes 36 for positioning.

The operation of the system constructed in this way is summarized as follows.

The foggy error correction amount map creation unit 6 of the controller 1 outputs the foggy error correction amount map 7. The global loading effect correction amount map creation unit 9 outputs the global loading effect correction amount map 10.

On the other hand, the proximity effect correction unit 13 receives the foggy error correction amount map 7, global loading effect correction amount map 10, the output from the pattern data file 2, pattern layout information 3, middle range loading effect correction parameters 11, micro-loading effect correction parameters 12, process error correction amount maps 16, transfer error correction amount maps 17, proximity effect correction parameters 18, and proximity effect correction maps 19, performs given calculations (described later), and outputs a proximity effect correction amount map 20.

After the pattern is expanded by the pattern expansion unit 21, the output from the pattern data file 2 is applied to the shot time-setting unit 22. The shot time-setting unit 22 receives the proximity effect correction amount map 20, determines a shot time, and attaches the shot time to the expanded pattern data. The shot time-setting unit 22 drives the beam deflection amplifier 23 for controlling the shot time, the beam deflection amplifier 29 for controlling the shot size, and the beam deflection amplifier 34 for controlling the irradiation position.

The stage position control unit 33 receives the proximity effect correction amount map 20, creates a stage position control signal, and drives the material-driving stage 27. As a result, a pattern is written with a dose optimal for the material 28 placed on the moving stage 27.

Because of these control operations, the shot pattern written on the material 28 is made appropriate. A method and system for charged-particle beam lithography for performing the dose corrections providing sufficient accuracy with simple processing can be offered. The operation of the present invention is hereinafter described in detail.

The dose of the electron beam on the resist is corrected to obtain desired pattern dimensions. For this purpose, an energy level (hereinafter referred to as level appropriate for the incidence) appropriate for the incident energy of the electron beam is matched to the energy level (hereinafter referred to as the process level) necessary for process steps, such as development and etching of the photoresist applied on the material surface.

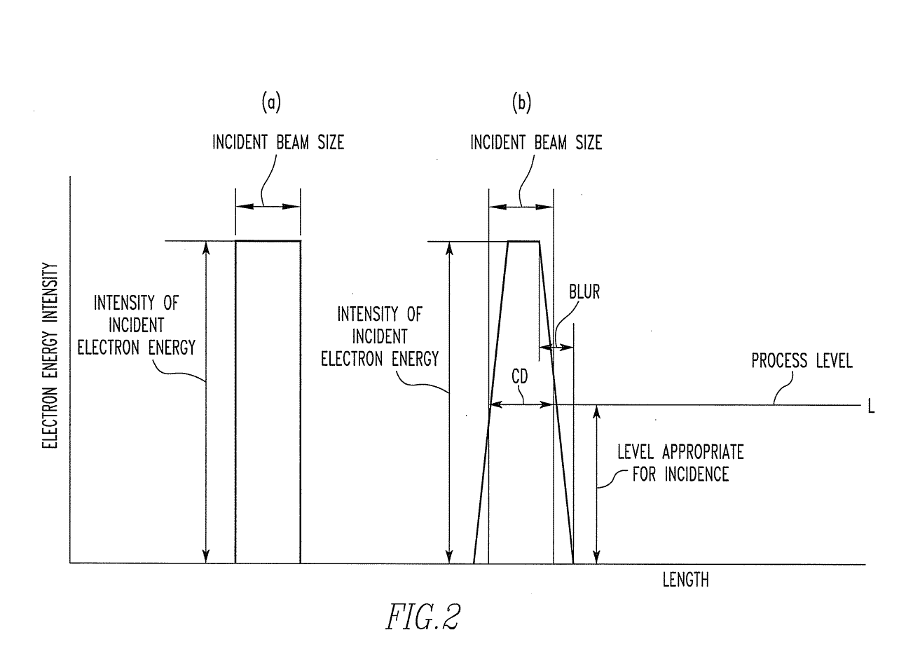

Electron energy is accumulated in the layer of the resist by the electron beam irradiation. Ideally, the distribution of the intensities of the electron energy is shown in graph (a) of FIG. 2. That is, the intensities should be uniform within the range of the incident beam size. In graph (a) of FIG. 2, length is plotted on the horizontal axis. Electron energy intensity is plotted on the vertical axis.

In practice, however, as shown in graph (b) of FIG. 2, the intensities of edge portions of the incident beam show tilted distribution lines due to blur of the beam. In FIG. 2, L indicates the process level. A beam size corresponding to the process level L is indicated by CD.

The intensity distribution lines of the incident beam at the edge portions are tilted in this way. Therefore, in order to form a pattern having the same size as the incident electron beam, a process in which the resist is developed and etched at a level appropriate for the incidence is necessary. At this time, the level appropriate for the incidence is set to 1/C2 of the intensity of the incident electron energy (where C2 is the ratio of the intensity of the incident electron energy to which the process level L should be matched). The process level L is matched to that value.

If the process level is set for the level appropriate for the incidence, a pattern having the same size as the size of the incident electron beam should be able to be formed. The intensities of electron energies accumulated in the layer of resist are affected by various factors including the energies of the incident energies. As a result, at the process level set to 1/C2 of the incident electron energy intensity, it may not be possible to form a pattern having the same size as the incident electron beam.

There are the following three factors leading to the situation in which the level appropriate for the incidence ceases to agree with the process level:

1. Accumulation of energy from the surroundings which depends on the dose different from the incident energy of the electron beam varies the level appropriate for the incidence (such as proximity effects and foggy errors).

2. The process level is made to vary due to different positions on the material and due to the rates of the etched areas in the surroundings (such as process errors and various loading effects).

3. The level appropriate for the incidence is intentionally varied in order to obtain desired pattern dimensions (such as transfer error correction).

With respect to these factors, the dose is so adjusted that the level appropriate for the incidence is brought into coincidence with the process level as described below.

First, components varying with the dose include proximity effects and foggy errors. In order to correct the components having effects varying with the dose, it does not suffice to correct the dose by amounts corresponding to the magnitudes of the effects. Rather, the dose must be matched taking account of variations of the effects corresponding to the corrected dose.

As mentioned previously, proximity effects are produced by scattering (forward scattering) of the incident electrons within the layer of resist and reflection (backward scattering) at the material surface located deeper than the resist layer. In particular, extra electron energies from relatively close surroundings other than the incident electron energy are accumulated in the layer of resist. Depending on the electron beam acceleration voltage (more than about 50 kV), the effects of the forward scattering are sufficiently smaller than the effects of the backward scattering. Therefore, generally, proximity effects are corrected, mainly taking account of the backward scattering.

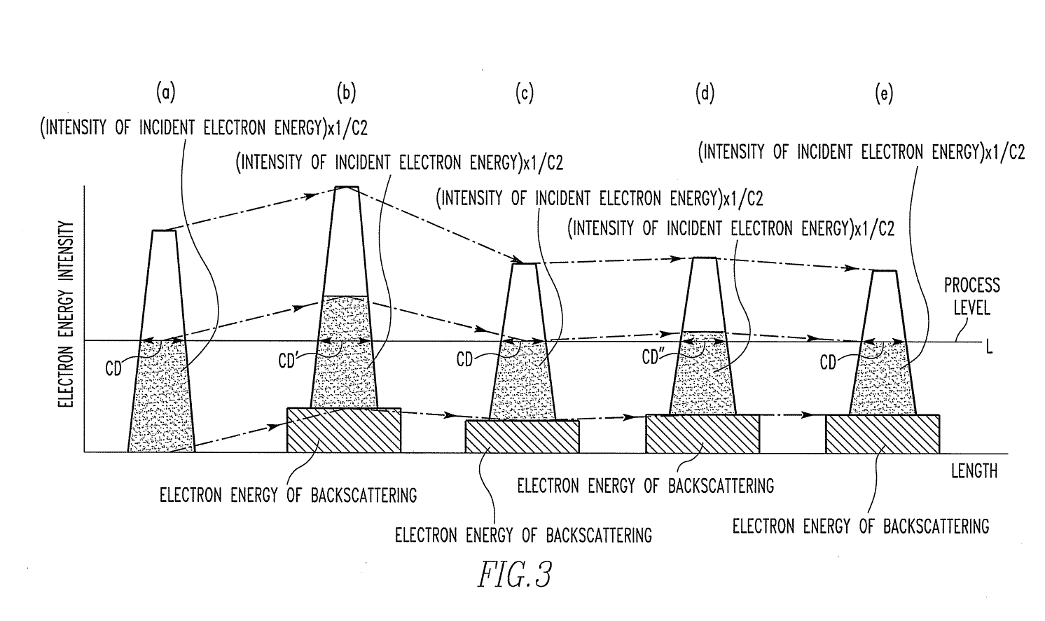

FIG. 3 shows the distribution of electron energy intensities accumulated in a layer of resist by electron beam irradiation. Graph (a) shows a state in which there are no proximity effects. Graph (b) shows a state in which there are proximity effects. Graph (c) shows a state in which proximity effects have been corrected. Graph (d) shows a state in which the effects of backscattering have been recalculated. Graph (e) shows a case in which proximity effects have been corrected based on the recalculated effects of backscattering.

In the state of graph (b) in FIG. 3 where proximity effects are produced, the level appropriate for the incidence is too high for the process level L. There is the tendency that the size of the formed pattern is increased by blurring of the beam.

Accordingly, as shown in graph (c) of FIG. 3, the incident electron energy and the electron energy of backscattering are adjusted by correcting the dose, thus matching the level appropriate for the incidence to the prior process level L.

However, as a result of correction of the dose as shown in graph (d) of FIG. 3, accumulation of electron energies of backscattering from nearby surroundings may deviate from the first estimation. Therefore, the level appropriate for the incidence may deviate from the process level.

To correct this, the electron energy of backscattering is reestimated based on the result of the correction of the dose. The dose is corrected based on the result as shown in graph (e) of FIG. 3. Consequently, the incident electron energy and the electron energy of the backscattering are adjusted. The level appropriate for the incidence is matched to the prior process level. These recalculations are performed plural times to cause the amount of correction to the dose to converge.

Foggy errors are produced by the following mechanism. Incident electrons are reflected at the resist surface. Diffuse reflections take place repeatedly between the resist surface and each component of the lithography system. During this process, extra electron energies are accumulated even in relatively remote portions of the layer of resist.

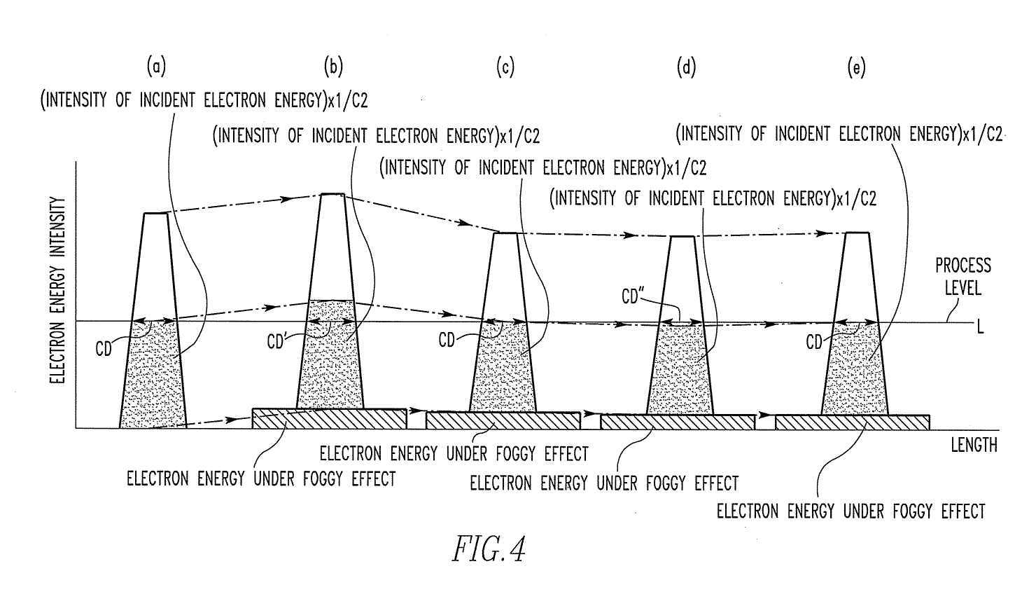

FIG. 4 shows the distribution of electron energy intensities accumulated in the layer of resist in response to electron beam irradiation. Graph (a) shows a state in which there is no foggy error. Graph (b) shows a state in which there is foggy error. Graph (c) shows a state in which foggy error has been corrected. Graph (d) shows a state obtained after recalculation of the foggy effects. Graph (e) shows a state in which foggy error has been corrected, based on recalculated foggy effects.

In the state of graph (b) in FIG. 4 where there is foggy error, the level appropriate for the incidence is too high for the process level L. There is the tendency that the size of the formed pattern is increased by blurring of the beam.

Accordingly, as shown in graph (c) of FIG. 4, the incident electron energy and electron energies under foggy effects are adjusted by correcting the dose. The level appropriate for the incidence is matched to the prior process level L.

However, as shown in graph (d) of FIG. 4, there is the possibility that accumulation of electron energies deviates from the first estimation due to foggy effects from remote surrounding portions as a result of the correction of the dose. Consequently, the level appropriate for the incidence may deviate from the process level.

To correct this, electron energies under foggy effects are recalculated based on the results of the correction of the dose. The dose is corrected based on the result as shown in graph (e) of FIG. 4. Consequently, the incident electron energy and the electron energies under foggy effects are adjusted. The level appropriate for the incidence is matched to the prior process level. These recalculations are performed plural times to cause the amount of correction to the dose to converge.

With respect to proximity effects and foggy errors caused by foggy effects, an amount of correction to the dose is calculated, treating the components of both kinds of effects comprehensively.

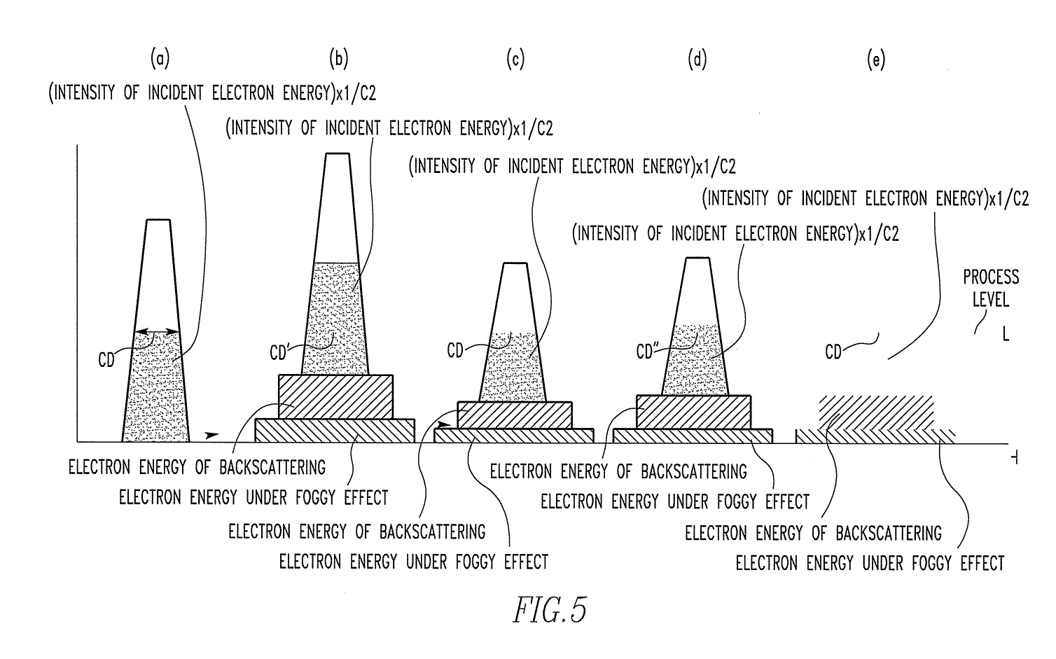

FIG. 5 shows the distribution of electron energy intensities accumulated in the layer of resist by electron beam irradiation. Graph (a) shows a state in which there are neither proximity effects nor foggy errors. Graph (b) shows a state in which there are proximity effects and foggy errors. Graph (c) shows a state in which proximity effects and foggy errors have been corrected. Graph (d) shows a state obtained after the effects of backscattering have been recalculated. Graph (e) shows a state in which proximity effects have been corrected, based on the recalculated effects of backscattering.

Incident electron energies and electron energies under proximity effects and foggy effects are adjusted by correcting the dose as shown in Graph (c) of FIG. 5. The level appropriate for the incidence is matched to the prior process level.

However, if all the components of both proximity effects and foggy errors are included, accumulation of electron energies due to backward scattering from nearby surroundings and due to the foggy effects from remote surroundings may deviate from the first estimation as a result of the correction of the dose. Consequently, the level appropriate for the incidence may deviate from the process level.

To correct this, if electron energies under the effects of backward scattering and foggy effects are recalculated taking account of the effects of correction to the dose, an optimum amount of correction to the dose can be obtained.

However, foggy effects reach a wide region on the material surface. Therefore, an exorbitant amount of computation and, thus, increased time are required to perform recalculation taking detailed account of all variations in foggy effects from nearby surroundings to remote surroundings caused by the correction of the dose.

The amount of correction to the dose is based on the assumption that the amount is calculated simultaneously with writing of a pattern on a material with an electron beam. Therefore, if the computation time is prolonged, the total throughput in the electron beam lithography will be deteriorated. Accordingly, to suppress the amount of computation, the area under foggy effects is divided into relatively large cells. It is assumed that in each cell, electron energies undergo uniform foggy effects.

In each cell, an optimum amount of correction to the dose is recalculated taking account of only foggy effect components. It is assumed that electron energies which are under the foggy effects and which have derived the final amount of correction to the dose are electron energies which are under the foggy effects and which are obtained when zeroth recalculation is performed in a case where an amount of correction to the dose is calculated taking account of all the components of proximity effects and foggy error components.

Electron energies under the foggy effects will be varied if these electron energies are taken into consideration together with the effects of backward scattering when the zeroth recalculation is performed. As shown in graph (d) of FIG. 5, electron energies which are under the foggy effects and which are calculated at the zeroth recalculation are regarded as having been derived under the conditions where the foggy effects have been already converged sufficiently. The electron energies are not varied at the first and following recalculations.

Subsequently, electron energies undergoing backward scattering are reestimated (or recalculated). Based on the results, the dose is corrected as shown in graph (e) of FIG. 5. Consequently, incident electron energies and the electron energies of backward scattering are adjusted. The level appropriate for the incidence is matched to the prior process level. The amount of correction to the dose is made to converge by performing the recalculation plural times.

Components affected by variations in the process level are produced by variations in process sensitivity (process velocity) in an etching process after development of the resist.

Some factors (process errors) resulting in these components depend on variations in process sensitivity across positions on the material surface. Other factors (various loading effects) depend on variations in the proportion of written area around the written pattern.

Some of the loading effects (micro-loading effects) depend on local proportions of written area of the written pattern. Others of the loading effects (middle range loading effects) depend on the proportions of written area of nearby surroundings. Still others of the loading effects (global loading effects) depend on proportions of written area of remote surroundings. It is considered that these effects are local variations of the process level.

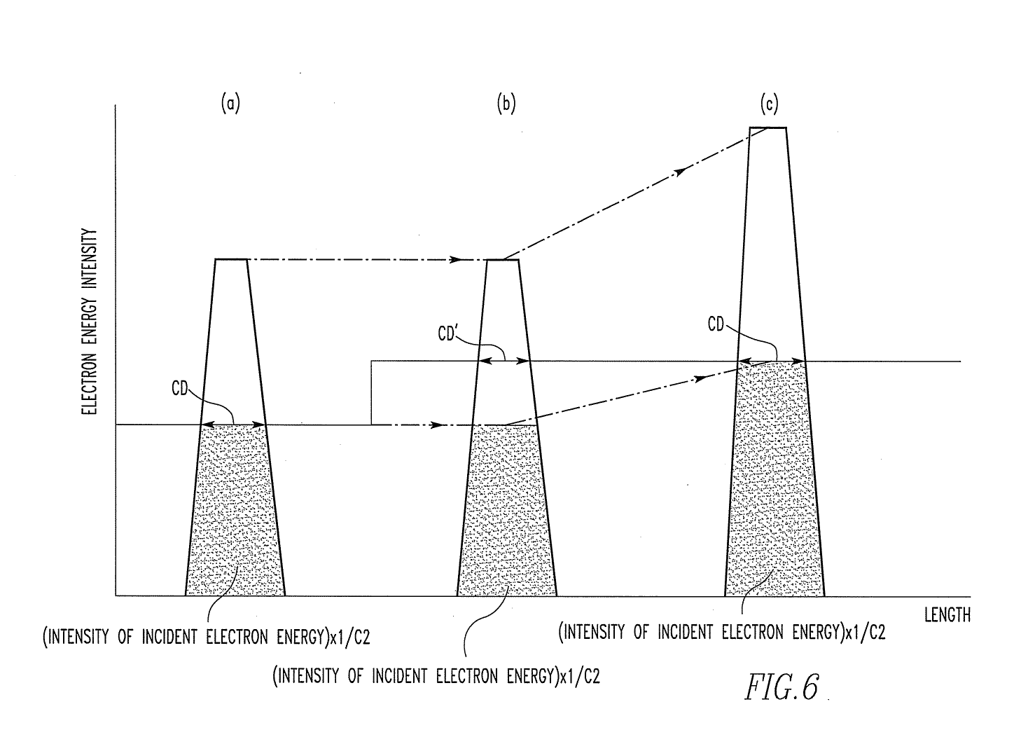

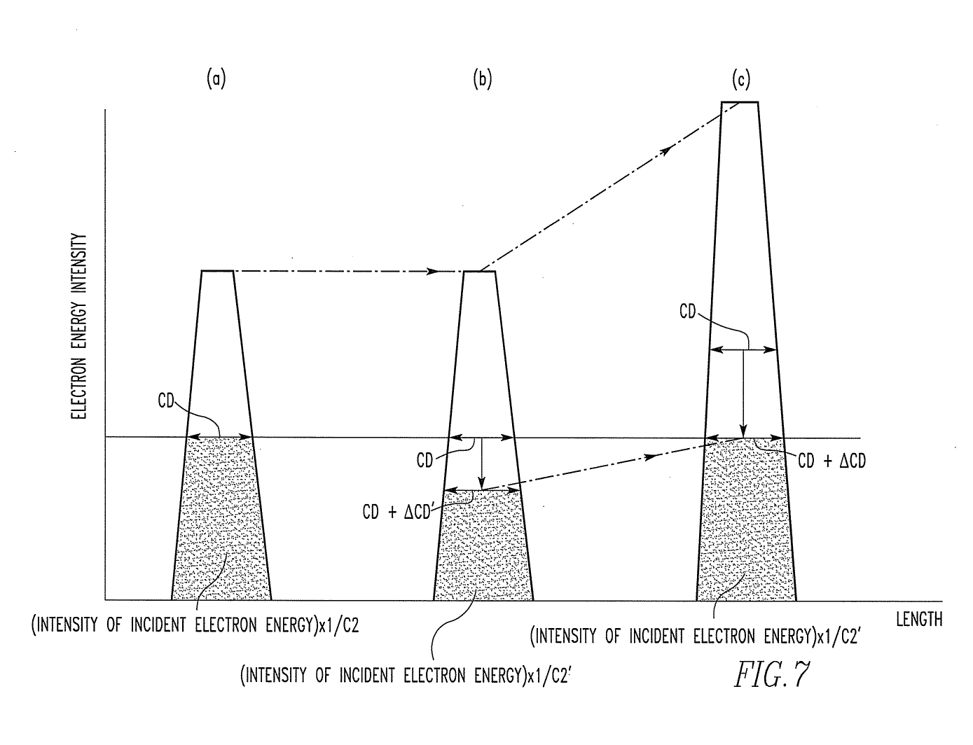

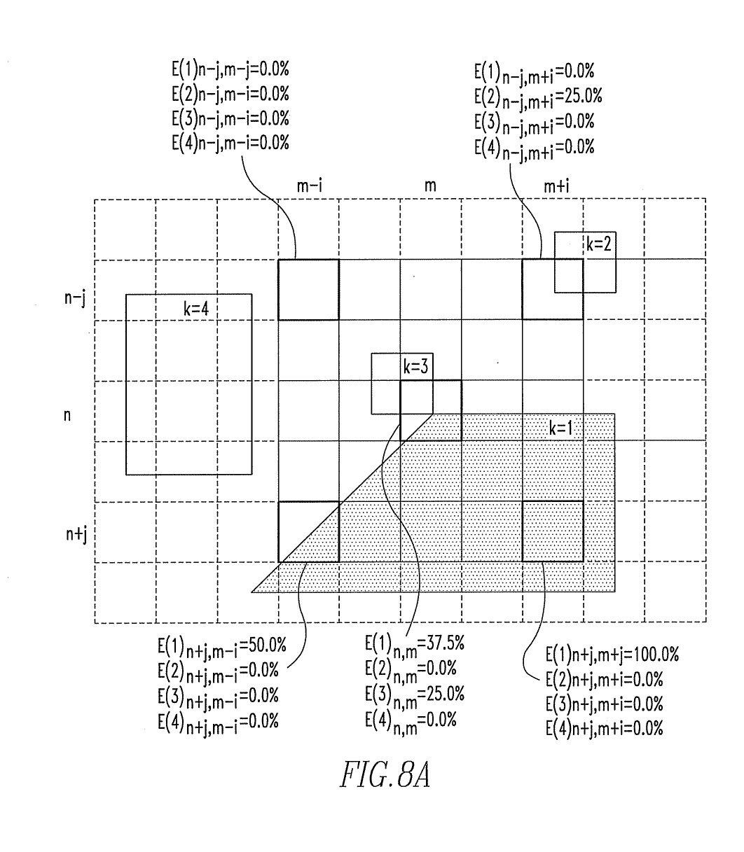

FIG. 6 shows the distribution of electron energy intensities accumulated in the layer of resist by electron beam irradiation. Graph (a) shows a state in which the energy level necessary for the process does not vary. Graph (b) shows a state in which the energy level necessary for the process has varied locally. Graph (c) shows a state in which the dose has been corrected according to the energy level necessary for the process that has varied locally.

Where the process level is varied as shown in graph (b) of FIG. 6 in order to correct variations in the dimensions of the pattern due to the above-described components, the dose is corrected as shown in graph (c) of FIG. 6 to bring the level appropriate for the incidence into coincidence with the varied process level.

Finally, effect components are produced by varying the level appropriate for the incidence intentionally in order to obtain desired dimensions of pattern.

When a pattern is transferred onto a wafer by a stepper using a mask plate created by an electron beam lithography system, variations (transfer errors) in pattern dimensions are produced. In order to correct these variations, the dose is corrected to intentionally vary the pattern dimensions when a pattern is written on the mask plate. As a result, these effect components are produced.

The correction is made to vary the size of the formed pattern by intentionally varying 1/C2 (i.e., the level appropriate for the incidence) of the incident electron energy intensity at which development or etching is done by making use of blurring of the electron beam.

Where the process level is constant, the dimensions of the formed pattern are varied by varying the dose.

FIG. 7 shows the distribution of electron energy intensities accumulated in the layer of resist by electron beam irradiation. Graph (a) shows a state in which the pattern dimensions are not corrected by a transfer error correction. Graph (b) shows a state in which the energy level necessary for the process has varied locally.

As shown in graph (b) of FIG. 7, let CD be a dimension of a pattern obtained by an ordinary process. Let C2′ be the ratio of incident electron energy intensity in order to obtain a pattern dimension of CD+ΔCD. The dose of the incident electron beam is corrected to bring 1/C2′ of the optimum incident electron energy intensity as shown in graph (c) of FIG. 7 into coincidence with the process level.

The amount of correction to the dose is calculated taking account of all the above-described three factors (i.e., (i) proximity effects/foggy errors, (ii) process errors/loading effects, and (iii) transfer errors) by performing the following operations by an electron beam lithography system that carries out proximity effect corrections embracing various dose corrections.

(1) Correction of Effects Varying with the Dose

The proximity effects and the effects of foggy errors vary with the dose. In order to correct these effects by the dose, it is necessary to correct the dose by an amount corresponding to the magnitude of the effects. In addition, it is necessary to adjust the dose taking account of variations in the effects caused by the correction to the dose. Accordingly, the amount of correction Smod_{n,m} to the dose in a cell (n,m) where proximity effects are corrected is found from the following equation:

$$S {mod}_{n , m} = \frac{C 1}{1 + C 2 \times ( \begin{matrix}{Ebp}_{n , m} \times η \times ( {Ebcor}_{n , m} + 1 ) + \\ {Efog}_{n , m} \times ( {Efcor}_{n , m} + 1 )\end{matrix} )} - 1 \qquad ( 1 )$$

where C1 is the ratio of the process level of the development-etching step to be adjusted, C2 is the ratio of the incident electron energy intensity to be adjusted, and η indicates the ratio of the energy of backscattering electron to the incident electron. These ratios are constants. Ebp_{n,m} indicates the ratio of the magnitude of proximity effects. Ebcor_{n,m} indicates the amount of correction to Ebp_{n,m} at the cell (n,m) where proximity effects are corrected, i.e., a position on the mask plate. Efog_{fn,fm} indicates the magnitude of the effects of foggy errors. Efcor_{n,m} indicates the amount of correction to Efog_{fn,fm} at the cell (n,m) where proximity effects are corrected, i.e., a position on the mask plate.

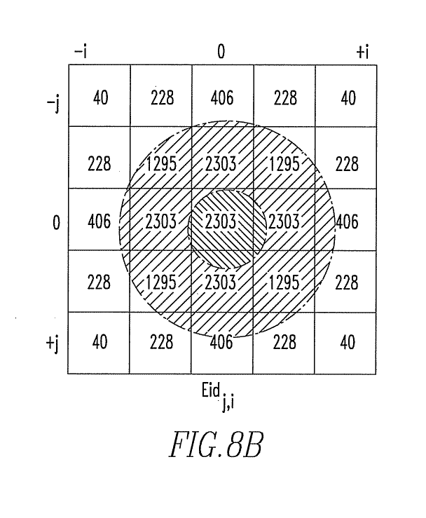

Ebp_{n,m} indicating the ratio of the magnitude of proximity effects is found for each cell from the following relational formula. Each cell measures about 0.1 to 1.0 μm square.

$${Ebp}_{n , m} = \frac{{\sum }_{k = 1}^{f} {\sum }_{i = - r}^{r} {\sum }_{j = - r}^{r} {E ( k )}_{n + j , m + i} \times {Eid}_{j , i}}{{\sum }_{i = - r}^{r} {\sum }_{j = - r}^{r} {Eid}_{j , i}} \qquad ( 2 )$$

where E(k)_{n,m} indicates the ratio of the amount of electron energy incident on each cell (n,m) when an arbitrary geometric figure k is written. Eid_{i,j} indicates the distribution of the intensities of backscattering electron energies, the intensities being given to surrounding cells (i,j) by incident electrons. f indicates the number of geometric figures contained in the pattern data (see FIGS. 8A and 8B).

FIG. 8A is a diagram showing the rate of electron energy incident on each cell (n,m) when an arbitrary figure k is written. FIG. 8B shows Eid_{i,j} that gives an example in which effects from the surroundings have been taken into account.

FIGS. 8A and 8B are now described in detail. k=1 to 4 indicates patterns. Apart from this, matrices each consisting of 5×5 cells are assumed. The degree of effect of each pattern on the E(k)_{n,m} of each matrix is shown. For example, the effect of pattern k=1 on a cell (n−j, m−i) is 0.0%. The effect of k=2 is 0.0%. The effect of k=3 is 0.0%. The effect of k=4 is 0.0%. The effect of pattern k=1 on a cell (n+j, m+i) is 100.0%. The effect of k=2 on the cell is 0.0%. The effect of k=3 on the cell is 0.0%. The effect of k=4 on the cell is 0.0%.

Similarly, the effect of k=1 on cell (n,m) is 37.5% because the pattern k=1 has encroached on other regions. The effect of k=2 is 0.0%. The effect of k=3 is 25.0% because the pattern k=3 has encroached on the other regions. The effect of k=4 is 0.0%, and so forth.

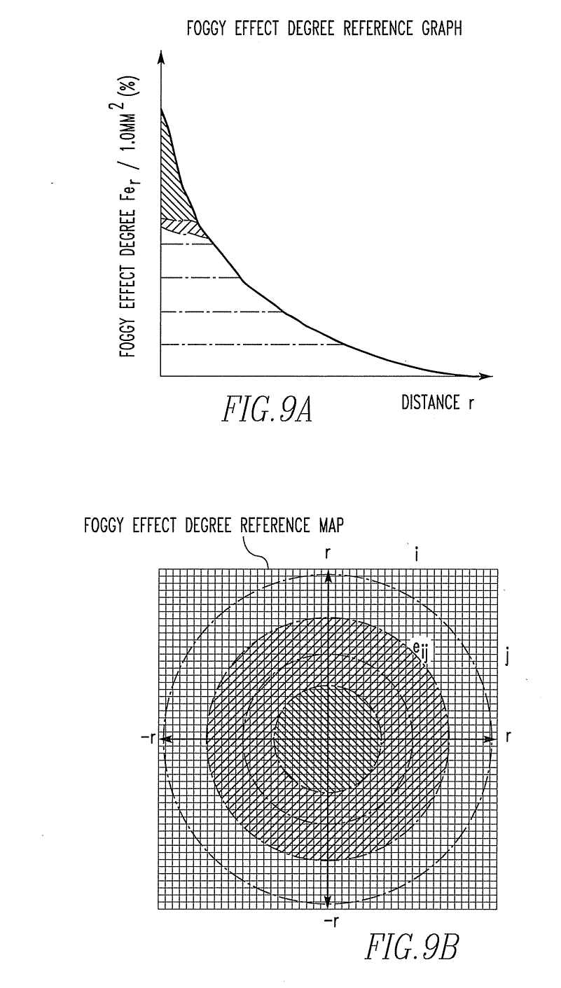

Efog_{fn,fm} indicating the magnitude of the effects of the foggy errors is found from the following relational formula for each cell (fn, fm) for correction of foggy errors. Each cell measures about 0.1 to 1.0 mm square.

$${Efog}_{fn , fm} = \frac{{\sum }_{fi = - fr}^{fr} {\sum }_{fj = - fr}^{fr} ( {S}_{fn + j , fm + i} \times {Fe}_{fj , {f}_{i}} )}{{\sum }_{i = - fr}^{fr} {\sum }_{j = - fr}^{fr} {Fe}_{fj , fi}} \qquad ( 3 )$$

where S_{fn,fm} is the proportion of the written area of the cell (fn, fm) on the mask plate. Fe_{fi,fj} is a foggy effect degree reference map (see FIGS. 9A and 9B) for each cell (fi, fj) found from the degree of effect Fe_{fr} due to foggy error per 1.0 mm² of the written area corresponding to the distance previously experimentally found.

FIG. 9A shows a foggy effect degree reference graph. The vertical axis indicates the foggy effect degree Feᵣ (%) per 1.0 mm². The horizontal axis indicates distance r. FIG. 9B indicates a foggy effect degree reference map Fe_{i,j}. Characteristics indicated in FIG. 9A show that the effect decreases with increasing the distance r. If the characteristics are extended to two-dimensionality, then characteristics shown in FIG. 9B are obtained. It can be seen that portions closer to the center point exert greater effects.

Proximity effects and foggy errors must be evaluated taking account of the effects of variations in doses in the surroundings as well as the effects of variations in their own doses. Accordingly, it is necessary to reestimate the degree of effect using the amount of correction to the dose once calculated. Therefore, the amount of correction to the dose obtained by the recalculation, Smod′_{n,m}, is found from the following calculational formula:

S mod′_{n,m}=C1−(1+C2×(Ebp′_{n,m}×η×(Ebcor_{n,m}+1)+Efog′_{n,m}×(Efcor_{n,m}+1))) (4)

Ebp′_{n,m} indicating the ratio of the magnitude of proximity effects is found from the following relational formula:

$${Ebp}_{n , m}^{′} = \frac{{\sum }_{k = 1}^{f} {\sum }_{i = - r}^{r} {\sum }_{j = - r}^{r} {E ( k )}_{n + j , m + i} \times {Eid}_{j , i} \times ( S {mod}_{n + j , m + i} + 1 )}{{\sum }_{i = - r}^{r} {\sum }_{j = - r}^{r} {Eid}_{j , i}} \qquad ( 5 )$$

At the second and following recalculations, a part of the difference between the amount of correction Smod^{now}_{n,m} to the dose found at this time and the amount of correction to the dose Smod^{before}_{n,m} found the previous time is applied (feedback coefficient FB). This improves the efficiency at which the amount of correction to the dose Smod′_{n,m} is converged by recalculations.

$$\begin{matrix}{Ebp}_{n , m}^{′} = \frac{{\sum }_{k = 1}^{f} {\sum }_{i = - r}^{r} {\sum }_{j = - r}^{r} {E ( k )}_{n + j , m + i} \times {Eid}_{j , i} \times ( S {mod}_{n + j , m + i}^{FB} + 1 )}{{\sum }_{i = - r}^{r} {\sum }_{j = - r}^{r} {Eid}_{j , i}} & ( 6 ) \\ S {mod}_{n , m}^{FB} = FB \times ( S {mod}_{n , m}^{now} - S {mod}_{n , m}^{before} ) + S {mod}_{n , m}^{before} & ( 7 )\end{matrix}$$

where Smod^{FB}_{n,m} is the shot time modulation amount at the cell (n,m) of the proximity effect correction found by the previous computation.

Meanwhile, it is necessary to reestimate the effect of foggy error regarding Efog′_{fn,fm} indicating the magnitude of the effect of the foggy error. Since the effect of the foggy error reaches a wide range on the mask plate, it is necessary to perform recalculation of the proximity effect correction for each cell, taking account of the effects of the proximity effect correction. This requires an exorbitant amount of computation. Where the effects on the lithographic throughput are taken into consideration, it is unrealistic to perform such computation concurrently with lithographic writing for each lithographic field.

First, only Efog_{fn,fm} which is given as a component of foggy error is optimized. The optimized Efog*⁰_{fn,fm} and the amount of correction to the dose Smodfog⁰_{fn,fm} obtained at this time are used from the first calculation. At the zeroth recalculation, the effects of foggy error occurring in the correction to the dose as given by the above formula are varied according to the results. That is, Efog*⁰_{fn,fm}→Efog*¹_{fn,fm}. However, at the first and subsequent recalculations, the variation (Efog*¹_{fn,fm}→Efog*²_{fn,fm}) is inhibited. That is, Efog*¹_{fn,fm}→Efog*¹_{fn,fm}.

Optimization of the foggy error effect Efog_{fn,fm} is carried out using the following relational formula by a technique of recalculation.

Zeroth recalculation:

$${Efog}_{fn , fm} = \frac{{\sum }_{fi = - fr}^{fr} {\sum }_{fj = - fr}^{fr} {S}_{fn + fj , fm + fi} \times {Fe}_{fj , fi}}{{\sum }_{i = - fr}^{fr} {\sum }_{j = - fr}^{fr} {Fe}_{fj , fi}} \qquad ( 8 )$$

Zeroth recalculation:

$$S {mod fog}_{fn , fm} = \frac{C 1}{1 + C 2 \times {Efog}_{fn , fm} \times ( {Efcor}_{fn , fm} + 1 )} - 1 \qquad ( 9 )$$

First recalculation:

$${Efog}_{fn , fm}^{′} = \frac{\begin{matrix}{\sum }_{fi = - fr}^{fr} {\sum }_{fj = - fr}^{fr} {S}_{fn + fj , fm + fi} \times \\ {Fe}_{fj , fi} \times ( S {mod fog}_{fn + fj , fm + fi} + 1 )\end{matrix}}{{\sum }_{i = - r}^{r} {\sum }_{j = - r}^{r} {Fe}_{j , i}} \qquad ( 10 )$$

First recalculation:

S modfog′_{fn,fm}=C1−(1+C2×Efog′_{fn,fm}×(Efcor_{fn,fm}+1)) (11)

Second and following recalculations:

S modfog^{FB}_{fn,fm}=FB×(S modfog^{now}_{fn,fm}−S modfog^{before}_{fn,fm})+S modfog^{before}_{fn,fm} (12)

Second and following recalculations:

$${Efog}_{fn , fm}^{″} = \frac{\begin{matrix}{\sum }_{fi = - fr}^{fr} {\sum }_{fj = - fr}^{fr} {S}_{fn + fj , fm + fi} \times {Fe}_{fj , fi} \times \\ ( S mod {fog}_{fn + fi , fm + fi}^{FB} + 1 )\end{matrix}}{{\sum }_{fi = - fr}^{fr} {\sum }_{fj = - fr}^{fr} {Fe}_{fj , fi}} \qquad ( 13 )$$

Second and following recalculations:

S modfog″_{fn,fm}=C1−(1+C2×Efog″_{fn,fm}×(Efcor_{fn,fm}+1)) Efog″_{fn,fm}→Efog*⁰_{fn,fm}S mod fog″_{fn,fm}→S mod fog*⁰_{fn,fm} (14)

After convergence, Efog*⁰_{fn,fm} is applied to computation starting at the zeroth recalculation for computation of Smod. On the other hand, Smod fog⁰_{fn,fm} is applied to computation for finding Ebp_{n,m} and Smod_{n,m} at the zeroth recalculation.

$$\begin{matrix}S {mod}_{n , m} = \frac{C 1 \times ( {S mod fog}_{n , m}^{* 0} + 1 )}{\begin{matrix}( {S mod fog}_{n , m}^{* 0} + 1 ) + C 2 \times \\ ( \begin{matrix}{Ebp}_{n , m} \times η \times \\ ( {Ebcor}_{n , m} + 1 ) + {Efog}_{n , m}^{* 0}\end{matrix} )\end{matrix}} - 1 & ( 15 ) \\ {Ebp}_{n , m} = \frac{\begin{matrix}{\sum }_{k = 1}^{f} {\sum }_{i = - r}^{r} {\sum }_{j = - r}^{r} {E ( k )}_{n + j , m + i} \times {Eid}_{j , i} \times \\ ( {S mod fog}_{n + j , m + i}^{* 0} + 1 )\end{matrix}}{{\sum }_{i = - r}^{r} {\sum }_{j = - r}^{r} {Eid}_{j , i}} & ( 16 )\end{matrix}$$

The Efcor_{n,m} indicates the amount of correction to Efog_{fn,fm} at the position ((n,m) at which proximity effect is corrected) on the mask plate as described previously. The Ebp_{n,m} indicates the ratio of the magnitude of the proximity effect as mentioned previously, and is calculated by hardware for correcting the proximity effect.

Efog⁰_{n,m} and Smod fog⁰_{n,m} are Efog*⁰_{fn,fm} and Smod fog*⁰_{fn,fm}, respectively, which have been calculated in software and which have been expanded as the magnitude of the effect of the foggy error optimized at the proximity effect correction cell (n,m) within the cell (fn,fm) for foggy error correction by proximity effect-correcting hardware and the amount of correction to the dose obtained at this time, respectively.

η is the ratio of the energy of backscattering electrons to the incident electron energy as described previously. Its components have been heretofore contained in a table defining the relationship between the Ebp (ratio of the magnitude of the proximity effect) and Smod (amount of correction to the dose). In the present invention, it is necessary to calculate the Smod, taking account of both proximity effect correction and foggy error correction. Therefore, the ratio is given as a parameter to the proximity effect-correcting hardware to permit the proximity effect-calculating hardware itself to compute the Smod_{n,m} depending on Ebp_{n,m} calculated by the proximity effect-correcting hardware and on the Efog*⁰_{n,m} given by the software.

On the other hand, Efog*¹_{n,m} applied to the first and following recalculations are found as follows, using Smod_{n,m} obtained at the zeroth recalculation.

$${Efog}_{fn , fm}^{* 1} = \frac{{Efog}_{fn , fm}^{* 0} \times {Average ( {S mod}_{n , m} + 1 )}_{fn , fm}}{{S mod fog}_{fn , fm}^{* 0} + 1} \qquad ( 17 )$$

where Average (Smod_{n,m}+1)_{fn,fm} indicates the average value of dose correction ratios (Smod_{n,m}) at the proximity effect correction cell (n,m) within the foggy error correction cell (fn,fm). That is, a relational formula from which the dose correction amount Smod′_{n,m} is found at the first and following recalculations is as follows.

$$\begin{matrix}{S mod}_{n , m}^{′} = C 1 - ( 1 + C 2 \times ( {Ebp}_{n , m}^{′} η \times ( {Ebcor}_{n , m} + 1 ) {Efog}_{n , m}^{* 1} ) ) \\ where & ( 18 ) \\ {Ebp}_{n , m}^{′} = \frac{{\sum }_{k = 1}^{f} {\sum }_{i = - r}^{r} {\sum }_{j = - r}^{r} {E ( k )}_{n + j , m + i} \times {Eid}_{j , i} \times ( {S mod}_{n + j , m + i}^{FB} + 1 )}{{\sum }_{i = - r}^{r} {\sum }_{j = - r}^{r} {Eid}_{j , i}} & ( 19 ) \\ {S mod}_{n , m}^{FB} = FB \times ( {S mod}_{n , m}^{now} - {S mod}_{n , m}^{before} ) + {S mod}_{n , m}^{before} & ( 20 )\end{matrix}$$

(2) Corrections Made to Cope with Variations in Process Level

Corrections made to cope with variations in the process level include process error correction, micro-loading effect correction, middle range loading effect correction, and global loading effect correction. It is considered here that development-etching process level C1 is locally varied by factors such as process error, micro-loading effects, middle range loading effects, and global loading effects.

In order to make a correction using the dose while taking account of all of the above-described effects, it is necessary to make a correction to match the dose to the varied process level. Under conditions where each effect takes place alone, a shot time modulation amount that is sufficient to correct each effect independently is found for each correction cell, and all the shot time modulation amounts are summed up to find the overall shot time modulation amount for each correction cell. Because the process level in each cell varies by an amount corresponding to the shot time modulation amount for correcting the effect, a correction is made in each cell using a shot time modulation amount obtained by totalizing the values of C1 included in the above formulas. That is, the relational formulas for finding the amount of correction to the dose Smod_{n,m} determined taking account of all the corrections made to cope with variations in the process level are given as follows for each unit (n,m) for proximity effect correction.

Zeroth recalculation:

$${S mod}_{n , m} = \frac{\begin{matrix}C 1 \times ( {S mod fog}_{n , m}^{* 0} + 1 ) \times \\ ( {S mod procall}_{n , m} + 1 )\end{matrix}}{\begin{matrix}( {S mod fog}_{n , m}^{* 0} + 1 ) + C 2 \times \\ ( \begin{matrix}{Ebp}_{n , m} \times η \times \\ ( {Ebcor}_{n , m} + 1 ) + {Efog}_{n , m}^{* 0}\end{matrix} )\end{matrix}} - 1 \qquad ( 21 )$$

First and following recalculations:

S mod′_{n,m}=C1×(S mod procall_{n,m}+1)−(1+C2×(Ebp′_{n,m}η×(Ebcor_{n,m}+1)+Efog*¹_{n,m})) (22)

where

S mod procall_{n,m}=(S mod proc_{n,m}+1)×(S mod mlec_{n,m}+1)×(S mod lec_{n,m}+1)(S mod glec_{n,m}+1) (23)

where Smod proc, S mod mlec, S mod lec, and S mod glec indicate shot time modulation amounts applied to each proximity effect correction cell for correction of process errors, micro-loading effects, middle range loading effects, and global loading effects, respectively.

After Smod proc_{n,m} and S mod glec_{n,m} have been calculated by software, they are supplied to the proximity effect-correcting hardware. Meanwhile, S mod mlec_{n,m} and S mod lec_{n,m} are calculated by the proximity effect-correcting hardware in accordance with the previously given specifications. S mod procall_{n,m} is calculated by the proximity effect-correcting hardware.

(3) Correction for Intentionally Varying the Level Appropriate for the Incidence

Correction for intentionally varying the matched intensity of the incident electrons includes transfer error correction. It is considered here that transfer error varies the size of a pattern which is formed while intentionally varying the ratio C2 of the incident electron energy intensity used for development and etching by making use of blurring of the incident electron beam.

Where the process level is constant, the pattern formed while varying the dose is varied in size. Transfer error correction varies the dose. This, in turn, varies the ratio of the incident electron energy intensity used for development and etching to the process level. Accordingly, C2 in the above-described formulas is corrected with shot time modulation amount S mod proj for transfer error correction. That is, a relational formula for finding the amount of correction to the dose S mod taking account of the transfer error correction is given by the following formulas for each proximity effect correction cell (n,m).

Zeroth recalculation:

$${S mod}_{n , m} = \frac{\begin{matrix}C 1 \times ( {S mod fog}_{n , m}^{* 0} + 1 ) \times \\ ( {S mod procall}_{n , m} + 1 )\end{matrix}}{\begin{matrix}( {S mod fog}_{n , m}^{* 0} + 1 ) / ( {S mod proj}_{n , m} + 1 ) + C 2 \times \\ ( \begin{matrix}{Ebp}_{n , m} \times η \times \\ ( {Ebcor}_{n , m} + 1 ) + {Efog}_{n , m}^{* 0}\end{matrix} )\end{matrix}} - 1 \qquad ( 24 )$$

First and following recalculations:

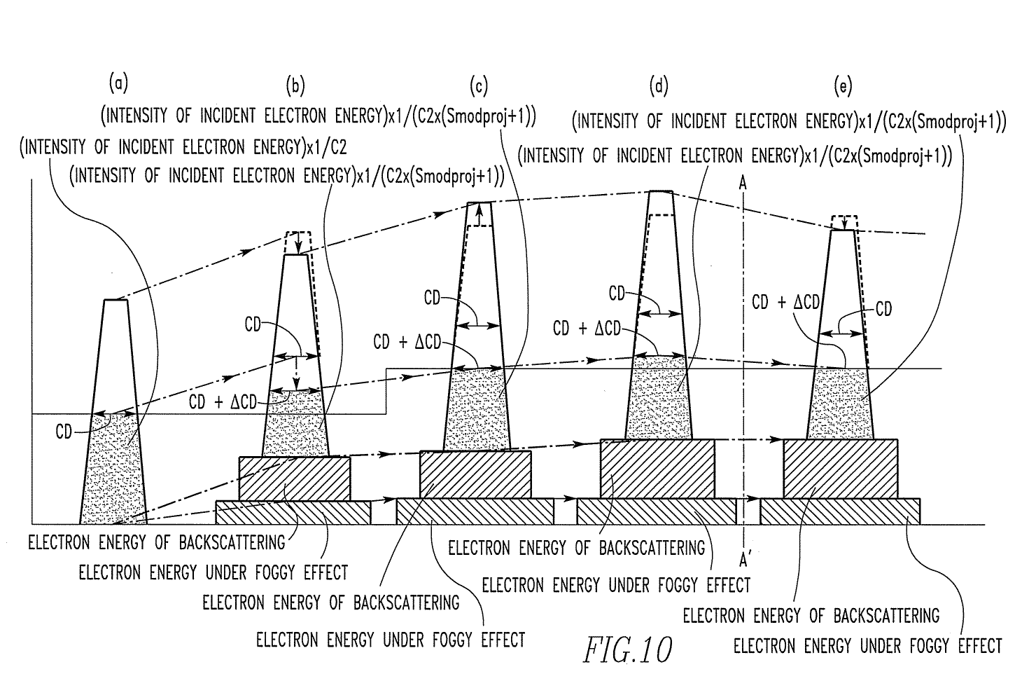

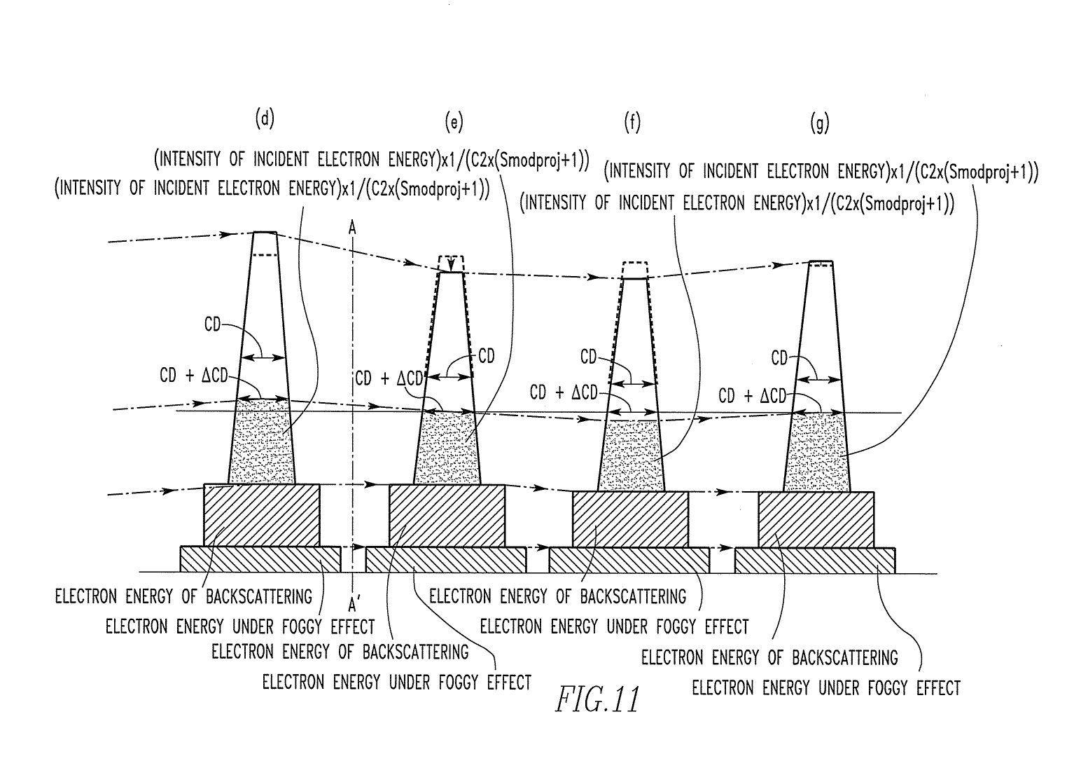

S mod′_{n,m}=(S mod proj_{n,m}+1)×(C1×(S mod procall_{n,m}+1)−C2×(Ebp′_{n,m}×η×(Ebcor_{n,m}+1)+Efog*¹_{n,m}))−1 (25)

where S mod proj_{n,m} is calculated by software and then supplied to the proximity effect-correcting hardware. The relationships among the steps of the correction algorithm are illustrated in FIGS. 10 and 11, which depict a sequence of algorithmic operations. Vertical Line A-A′ is common to both FIGS. 10 and 11. Accordingly, some waveforms are shown in both figures. In FIGS. 10 and 11, graph (a) shows a state in which there is not any kind of error. Graph (b) shows estimation of various errors. Graph (c) shows the zeroth recalculation of proximity effect correction. Graph (d) shows recalculation of the effects of backward scattering. Graph (e) shows the first recalculation of proximity effect correction. Graph (f) shows recalculation of the effects of backward scattering. Graph (g) shows the Nth recalculation of proximity effect correction.

(4) Incorporation of Various Dose Corrections into Proximity Effect Correction

In proximity effect correction made taking account of various kinds of dose corrections, the doses are all incorporated into the proximity effect correction. Therefore, in any of various kinds of dose corrections excluding the proximity effect correction, a single dose correction is not performed if proximity effect correction is involved. Meanwhile, where proximity effect correction is not involved, a single dose correction is performed in the same way as in the prior art. Shot time modulation amounts in proximity effect correction incorporating various kinds of dose corrections are as follows.

Zeroth recalculation:

$${S mod}_{n , m} = \frac{\begin{matrix}C 1 \times ( {S mod fog}_{n , m}^{* 0} + 1 ) \times \\ ( {S mod procall}_{n , m} + 1 )\end{matrix}}{\begin{matrix}( {S mod fog}_{n , m}^{* 0} + 1 ) / ( {S mod proj}_{n , m} + 1 ) + C 2 \times \\ ( \begin{matrix}{Ebp}_{n , m} \times η \times \\ ( {Ebcor}_{n , m} + 1 ) + {Efog}_{n , m}^{* 0}\end{matrix} )\end{matrix}} - 1 \qquad ( 26 )$$

First and subsequent recalculations:

S mod′_{n,m}=(S mod proj_{n,m}+1)×(C1×(S mod procall_{n,m}+1)−C2×(Ebp′_{n,m}×η×(Ebcor_{n,m}+1)+Efog*¹_{n,m}))−1 (27)

The method of correcting the lithography process with the dose as described so far is described by referring to the block diagram of FIG. 1.

In order to calculate the proximity effect correction amount determined taking account of various dose corrections, the controller 1 for the system creates a foggy error correction amount map 7 using a foggy error correction program from pattern data stored in the pattern data file 2, pattern layout information 3, foggy error correction parameters 4, and foggy error effect correction map 5.

Similarly, the controller creates the global loading effect correction map 10 using a global loading effect correction program from the pattern data in the pattern data file 2, pattern layout information 3, and global loading effect correction parameter 8.

The middle range loading effect correction parameters 11 and micro-loading effect correction parameters 12 are converted into a middle loading effect correction amount map 14 and the micro-loading effect correction amount map 15, respectively, in the proximity effect correction unit 13.

The proximity effect correction map 13 creates a proximity effect correction amount map 20 based on the aforementioned calculational formula from the pattern data in the pattern data file 2, pattern layout information 3, foggy error correction amount map 7, global loading effect correction amount map 10, middle range loading effect correction amount map 14, micro-loading effect correction amount map 15, process error correction amount maps 16, transfer error correction amount maps 17, proximity effect correction parameters 18, and proximity effect correction maps 19.

Meanwhile, the pattern data from the pattern data file 2 is transferred to the pattern expansion unit 21 from the controller 1, where the compressed data is expanded. The data is then transferred to the shot time creation unit 22, where the data is divided into shot pattern data sets about geometric figure elements having positions and sizes on the material 28 to be written. Shot time data based on the shot time modulation amount shown in the proximity correction maps 19 is attached to the shot pattern data sets according to the positions.

The beam deflection amplifier 23 for controlling the shot time applies a voltage based on the shot time to the beam deflection electrodes 24 for blanking and so the irradiation time (shot time) of the electron beam 26 directed at the material 28 from the electron beam source 25 is controlled.

On the other hand, the beam deflection amplifier 29 for controlling the shot size applies a voltage based on the size of the shot figure to the beam deflection electrodes 30 for shaping and so the electron beam from the electron beam source 25 is deflected between the beam-shaping slits 31 and 32. Consequently, the electron beam having a cross section of desired size is emitted from the beam-shaping slit 32.

The stage position control unit 33 moves the material-moving stage 27 to bring the lithography field in which a pattern is written onto the optical axis. Furthermore, the beam deflection amplifier 34 for controlling the irradiation position applies a voltage based on the position of the projected geometric figure to the beam deflection electrodes 35 for positioning. Consequently, the electron beam is made to hit a desired position within the lithography field.

The configuration designed as described so far makes it possible to provide a method and system for electron beam lithography which can provide sufficient accuracy with simple processing.

In the above embodiment, an example is taken in which an electron beam lithography system is used as a charged-particle beam lithography system. The present invention is not limited to this example. The present invention can also be applied to other systems and apparatus, such as an ion-beam lithography system. The present invention described so far yields the following advantages.

(A) To match the energy level (level appropriate for the incidence) appropriate for the incident energy of the charged-particle beam to the energy level (process level) necessary for the process of development and etching of the photoresist applied on the material surface, the dose of the beam, i.e., the amount of incidence of the charged-particle beam on the photoresist, is corrected. Consequently, a lithographic pattern having desired dimensions can be formed on the material.

(B) Heretofore, factors leading to deviations of the process level from the level appropriate for the incidence have been estimated individually and corrected with the dose. An amount of correction to the dose for correcting these deviations in one operation is calculated. This makes it unnecessary to perform a second operation in which mutual effects caused by corrections to those factors with the dose are corrected. The second operation is processing that is complex to perform. In addition, sufficient accuracy is not obtained.

(C) A dose correction amount (an amount of correction to the dose) that permits the proximity effect and the effect of foggy error to be corrected at the same time can be computed by understanding the proximity effect and foggy error as a phenomenon in which the level appropriate for the incidence ceases to agree with the process level by accumulation of energies which are separate from the incident energy of the charged-particle beam and which depend on the dose.

(D) Process error and various loading effects are understood as a phenomenon in which the process level is locally varied with position on the material and with rate of etched area in the surroundings. Other corrections to the dose are understood as corrections for matching the level appropriate for the incidence to the locally varied process level. In consequence, variations in the pattern dimensions caused by such factors can be corrected.

(E) A correction made using the dose to correct transfer error is understood as a correction for intentionally varying the level appropriate for the incidence. Other corrections using the dose are understood as corrections for matching the level, which is appropriate for the incidence and has been varied in this way, to the process level. Consequently, variations in the dimensions of the pattern due to such factors can be corrected.

(F) In the process where the doses of components varying with accumulation of energy dependent on the dose are calculated, increases in the amount of computation (computational time) for correcting the doses by the proximity effect correction unit can be suppressed by previously optimizing the effects of foggy error correction in each relatively large cell (i.e., the effect of foggy error is reestimated with a dose correction amount once obtained, then the dose correction amount is recalculated, and this sequence of operations is repeated).

The proximity effect correction made taking account of all of various corrections using the dose is performed based on the assumption that calculations are performed simultaneously with writing of a pattern on the material using the charged-particle beam. Therefore, adverse effects on the lithography throughput can be eliminated by suppressing the computational time.

(G) It is considered that the backward scattering coefficient (the ratio of the magnitude of the effect of backward scattering on forward scattering) indicating the magnitude of the proximity effect is constant across the surface of the material. It is possible to make corrections while coping with such variations by providing a function of making corrections on the assumption that the coefficient varies with position on the material surface.

(H) Although it is considered that the magnitude of foggy error effect per unit lithography area is constant across the material surface, it is possible to make corrections while coping with such variations by providing a function of making corrections on the assumption that the coefficient varies with position on the material surface.

Having thus described my invention with the detail and particularity required by the Patent Laws, what is desired protected by Letters Patent is set forth in the following claims.

The invention claimed is:

1. A method of charged-particle beam lithography for writing a pattern at a desired position on a material on which a resist is applied by directing a charged-particle beam at the position, said method comprising the step of:
correcting a dose of the charged-particle beam on the resist such that energy level (process level) necessary for a process such as development and etching of the resist applied on a surface of the material agrees with an energy level appropriate for incident energy of the charged-particle beam.

2. A method of charged-particle beam lithography as set forth in claim 1, wherein the dose is corrected in terms of at least one factor out of proximity effect, foggy error, process error, loading effects, and transfer error.

3. A method of charged-particle beam lithography as set forth in claim 2, wherein in a case where the dose is corrected in terms of the proximity effect, energies of charged particles due to backward scattering are recalculated based on results of the correction of the dose, then the dose is corrected based on results of the recalculation, and this sequence of operations is repeated.

4. A method of charged-particle beam lithography as set forth in claim 2, wherein in a case where the dose is corrected in terms of the foggy error, energies of charged particles due to the foggy error are recalculated based on results of the correction of the dose, then the dose is corrected based on results of the recalculation, and this sequence of operations is repeated.

5. A method of charged-particle beam lithography as set forth in claim 2, wherein the dose is corrected taking account of both proximity effect and foggy error, and wherein energies of charged particles due to backward scattering are recalculated based on results of the correction of the dose, then the dose is corrected based on results of the recalculation and on energies of charged particles due to foggy error recalculated separately, and this sequence of operations is repeated.

6. A method of charged-particle beam lithography as set forth in claim 5, wherein recalculation of the recalculated energies of the charged particles due to the foggy error is performed for each cell after a region on the material undergoing the foggy effect is divided into plural cells.

7. A method of charged-particle beam lithography as set forth in claim 2, wherein said loading effects in terms of which the dose is corrected include global loading effect, middle range loading effect, and micro-loading effect, and wherein the corrections in terms of these loading effects are made simultaneously with correction of the dose in terms of the process error.

8. A method of charged-particle beam lithography as set forth in claim 2, wherein the dose is corrected taking account of all of the proximity effect, foggy error, process error, and transfer error.

9. A method of charged-particle beam lithography as set forth in claim 2, wherein the dose is corrected in terms of all of the proximity effect, foggy error, process error, and transfer error to correct the proximity effect.

10. A method of charged-particle beam lithography as set forth in claim 2, further comprising the step of providing a function of making corrections based on the assumption that a backward scattering coefficient indicating the magnitude of the proximity effect varies with position on a surface of the material to be written.

11. A method of charged-particle beam lithography as set forth in claim 2, further comprising the step of providing a function of making corrections based on the assumption that the foggy error varies with position on the surface of the material to be written.

12. A charged-particle beam lithography system for writing a pattern at a desired position on a material having a layer of resist thereon by directing a charged-particle beam at the desired position based on lithographic data, said charged-particle beam lithography system comprising:
a proximity effect correction amount map creation unit for creating a proximity effect correction amount map from pattern data, pattern layout information, a foggy error correction amount map, loading effect correction amount maps, a process error correction amount map, a transfer error correction amount map, proximity effect correction parameters, and a proximity effect correction map; and
a lithographic data creation unit for creating lithographic data based on the pattern data, creating shot time data based on the proximity effect correction amount map supplied from the proximity effect correction amount map creation unit, and attaching the created data to the lithographic data.

13. A charged-particle beam lithography system as set forth in claim 12, wherein said foggy error correction amount map is created by a foggy error correction amount map creation unit from the pattern data, pattern layout information, foggy error correction parameters, and foggy error correction map.

14. A charged-particle beam lithography system as set forth in claim 12, wherein
(A) said loading effect correction amount maps include a global loading effect correction amount map, a middle range loading effect correction amount map, and a micro-loading effect correction amount map,
(B) said global loading effect correction amount map is created by the global loading effect correction amount map creation unit from the pattern data, pattern layout information, and global loading effect correction parameters,
(C) said middle range loading effect correction amount map is created from the middle range loading effect correction parameters, and
(D) said micro-loading effect correction amount map is created from the micro-loading effect correction parameters.
